(19) United States
(12) Patent Application Publication
(10) Pub. No.: US 2005/0093975 A1
(43) Pub. Date: May 5, 2005

(54) Adaptation of vision systems for commerical vehicles

(76) Inventors: Majed M. Hamdan, North Olmsted, OH (US); Dennis Losh, Farmington, MN (US)

Correspondence Address: MICHAEL J. D'AURELIO, 96 CHURCH STREET, CHAGRIN FALLS, OH, 44022, US

(21) Appl. No.: 10/972,664

(22) Filed: Oct. 25, 2004

Related U.S. Application Data
(60) Provisional application No. 60/515,890, filed on Oct. 30, 2003.

(51) Int. Cl. H04N 9/47

(52) U.S. Cl. 348/118

(57) ABSTRACT

A vision system interface and method are provided for use in a commercial vehicle. In one embodiment, the vision system interface comprises at least one input through which at least one of a plurality of video signals is received from a corresponding plurality of cameras for display on a display device. The vision system interface also comprises a vision system controller facilitating a selection of at least one of the video signals that is to be displayed on the display device, the vision system controller being adapted to generate at least one message to be displayed on the display device. The vision system interface further comprises a screen overlay controller adapted to overlay the at least one message onto the at least one selected one of the video signals for display on the display device.

### CROSS REFERENCE TO RELATED APPLICATIONS

The present patent application claims priority to U.S. Provisional Patent Application entitled “Adaptation of Vision Systems to Commercial Vehicles” filed on Oct. 30, 2003 and assigned Application No. 60/515,890.

### BACKGROUND

Many accidents and other traffic problems that occur on the road are often attributable to the inability of drivers to see hazards before it is too late. For example, in many vehicles a driver may not be able to see all areas of the road due to so called “blind spots”. Alternatively, while driving at night, a driver may not be able to see much farther than the area in front of the vehicle that is illuminated by headlights. In addition, a driver's vision may be compromised in other ways due to weather and other factors, etc. In response to these problems, the makers of automobiles have developed cameras that provide views of blind spots and infrared views of the road that greatly enhance the vision of a driver in such circumstances.

The above-mentioned problems of vision obstruction and limitations are typically compounded when commercial vehicles such as trucks and the like are considered. For example, blind spots in a large truck are much larger than those associated with a car. Also, if the view of a driver of a large truck is limited due to darkness, the truck might not be able to stop within the amount of roadway that they can actually see if a hazard suddenly presented itself due to the increased weight of the truck and maneuvering limitations. In such a situation, an infrared camera may provide a clear view of hazards beyond the roadway that is visible to the driver, thereby allowing quicker response and providing greater stopping room. Also, commercial drivers may be made aware of hidden areas around large trailers, etc.

As such, the use of cameras on commercial vehicles may enhance the ability of drivers to avoid accidents and hazards. Unfortunately, commercial vehicles typically present a hostile environment for the use of video imaging equipment as opposed to the environment presented by cars. Specifically, commercial vehicles often generate greater vibration, temperature variation, power irregularities, and other environmental problems typically not seen in cars.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a drawing of a commercial vehicle that employs vision systems according to an embodiment of the present invention;

FIG. 2 is a block diagram that illustrates an example of a vision system interface employed in the vision system on the commercial vehicle of FIG. 1 according to an embodiment of the present invention;

FIG. 3 is a schematic of a control processor that is included in the vision system interface of FIG. 2 according to an embodiment of the present invention;

FIG. 4 is a schematic of an imaging processor that is included in the vision system interface of FIG. 2 according to an embodiment of the present invention;

FIG. 5 is flow chart that illustrates an example of the overall operation of the vision system controller executed in the control processor of FIG. 3 according to an embodiment of the present invention;

FIG. 6 is a flow chart that illustrates an example of the operation of the screen to screen analyzer executed in the imaging processor of FIG. 4 according to an embodiment of the present invention; and

FIG. 7 is a flow chart that illustrates an example of the operation of a second portion of the vision system controller executed in the control processor of FIG. 3 according to an embodiment of the present invention.

### DETAILED DESCRIPTION

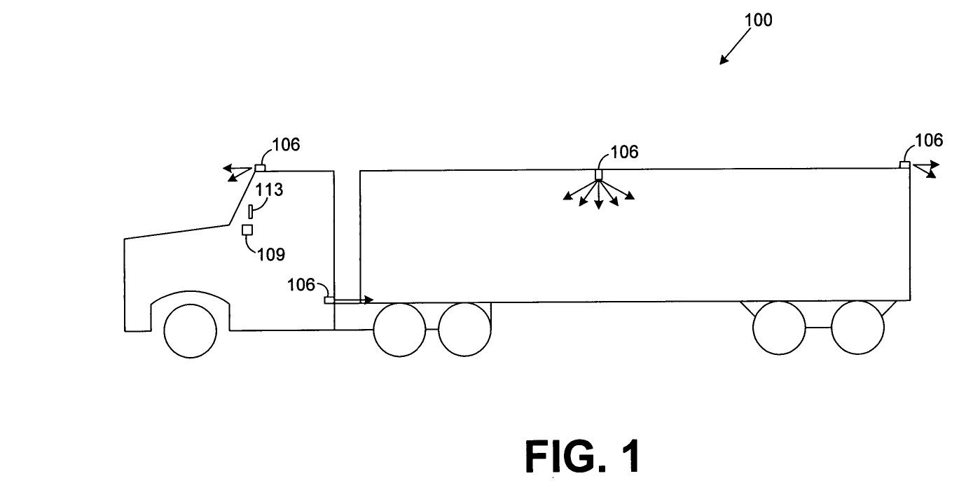

With reference to FIG. 1, shown is an example of a commercial vehicle 100 according to an embodiment of the present invention. The commercial vehicle 100 includes a number of cameras 106 that are disposed at various locations on the commercial vehicle 100 to provide views of the environment surrounding the commercial vehicle 100. The cameras 106 may be digital cameras or analog cameras. Any number of cameras 106 may be positioned on the commercial vehicle 100 to obtain a corresponding number of views of the area around the commercial vehicle 100. Also disposed within the commercial vehicle 100 are a vision system interface 109 and a display screen 113. Each of the cameras 106 and the display screen 113 are electronically coupled to and communicate with the vision system interface 109 as will be discussed.

The vision system interface 109 facilitates the use of digital video equipment on the commercial vehicle 100 that may be, for example, a semi (tractor/trailer) as shown. Alternatively, the vision system interface 109 may be employed in conjunction with cameras 106 and display devices 113 on any other type of commercial vehicle such as, for example, delivery trucks, construction vehicles, earth moving equipment and other vehicles and equipment. The vision system interface 109 performs several functions to facilitate the display of digital images generated by the cameras 106 and incorporates other functionality as will be discussed. For example, the vision system interface 109 provides for power conditioning of power generated by various power sources in commercial vehicles for use with sensitive digital equipment such as the cameras 106, the display device 113, and various other sensitive circuitry. Also, the vision system interface 109 provides for the switching between the multiple cameras 106 to display a desired view from one of the cameras 106 on the display device 113.

In addition, the vision system interface 109 also facilitates the display of pertinent operational and diagnostic information associated with operation of a commercial vehicle 100 to be viewed by an operator. The vision system interface 109 also provides for analysis of views from cameras 106 disposed in various positions around a commercial vehicle. These features and more aspects of the vision system interface 109 will be discussed in the following text. For purposes of clarity, the following description begins with a discussion of the physical makeup of the vision system interface 109 that is followed by a discussion of the operation of the vision system interface 109.

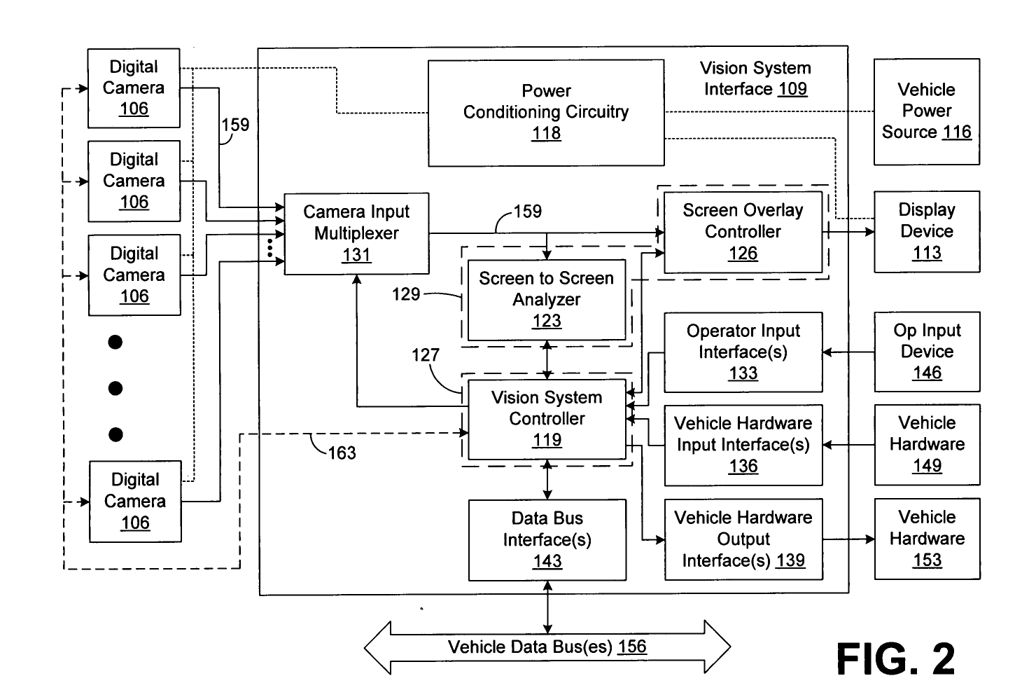

With reference to FIG. 2, shown is a schematic of the vision system interface 109 according to an embodiment of the present invention. The vision system interface 109 may comprise, for example, a circuit board with electrical circuitry as will be described. Also, many of the components in the vision system interface 109 may be embodied in an Application Specific Integrated Circuit (ASIC). The vision system interface 109 receives power from a vehicle power source 116 in the commercial vehicle 100 such as 12 Volt DC, for example, a battery or an alternator, as is generally known by those with ordinary skill in the art. The power from the vehicle power source 116 is conditioned by power conditioning circuitry 118 according to an embodiment of the present invention.

The power conditioning circuitry 118 serves to filter or condition the power received from the vehicle power source 116 to prevent voltage surges, voltage transients, and other power abnormalities from reaching components on the vision system interface 109, the cameras 106, or the display device 113. In this respect, power that is conditioned or filtered by the power conditioning circuitry 118 is then provided to the cameras 106 and the display device 113 as shown. Alternately, the cameras 106 and the display device 113 may each include power conditioning circuitry that operates in a manner similar in scope with the power conditioning circuitry 118. For a more detailed understanding of examples of the power conditioning circuitry 118, reference is made to U.S. Provisional Patent Application Ser. No. 60/421,189 filed on Oct. 25, 2002, and co-pending U.S. patent application entitled “Electrical Transient Protection Circuit” filed on Oct. 24, 2003 under Attorney Docket Number 591-02-071, such references being incorporated herein by reference.

The vision system interface 109 also includes a number of functional components such as, for example, a vision system controller 119, a screen to screen analyzer 123, and a screen overlay controller 126. The vision system controller 119 performs many functions, one of which is controlling a camera input multiplexer 131 to determine which view generated by which one of the cameras 106 is displayed on the display device 113 as will be described.

The vision system interface 109 may include one or more microprocessor circuits or controllers that facilitate various functionality to accomplish the operational aspects of the vision system interface 109. In one embodiment, the vision system interface 109 includes a control processor 127 that may be, for example, a microcontroller to facilitate the execution of the vision system controller 119. In addition, the vision system interface 109 includes an image processor 129 that may be, for example, a microcontroller to facilitate the execution of the screen to screen analyzer 123 and the screen overlay controller 126. In these respects, the microcontrollers include processor circuits having a processor and a memory as can be appreciated by those with ordinary skill in the art and as will be further discussed. However, it is appreciated that any number of microcontrollers may be employed in the vision system interface 109 as necessary to accomplish the various operational tasks performed thereby. Also, it may be possible that a single microprocessor circuit be used in place of the control processor 127 and the image processor 129 if such a microprocessor circuit includes the capacity to execute the vision system controller 119, the screen to screen analyzer 123, and the screen overlay controller 126.

The vision system interface 109 includes a number of input and output interfaces including, for example, one or more operator input interfaces 133, vehicle hardware input interfaces 136, vehicle hardware output interfaces 139, and one or more data bus interfaces 143. These interfaces 133, 136, 139, 143 generally make signals received from input devices accessible to the control processor 127 and facilitate the transmission of output signals from the control processor 127 to output devices. In particular, the vision system controller may receive various input via the operator input interfaces 133 from various operator input devices 146 that are made available to drivers of the commercial vehicle 100 (FIG. 1). Such operator input devices 146 may comprise, for example, push buttons, graphical user interfaces, microphones, keyboards, and other user input devices as can be appreciated by those with ordinary skill in the art. In this manner, a driver or operator may manipulate the operator input devices 146 to provide particular control over the various functions of the vision system controller 119 in displaying various views from the cameras 106 onto the display device 113. In addition, the display device 113 may provide touch screen capabilities that allow an operator to input information to the vision system controller 119.

The vehicle hardware input interfaces 136 make input signals generated by various vehicle hardware 149 available to the control processor 127 and the vision system controller 119. In this respect, the vehicle hardware 149 may comprise, for example, various subsystems that generate inputs within the commercial vehicle 100 such as, for example, brake subsystems, turn signal subsystems, steering systems, lift axle systems, pressure sensors, temperature sensors, fifth wheel position systems and other systems. In addition, the vehicle hardware 149 may further comprises voice recognition subsystems that convert voice commands from an operator into inputs provided to the vision system controller 119.

By virtue of the vehicle hardware 149 and the vehicle hardware input interfaces 136, various information may be provided to the vision system controller 119 about the operation of the commercial vehicle 100 such as, for example, if the driver is attempting to stop the vehicle by pressing on the brakes. In such case, the braking system may provide an input signal into the vision system controller 119 through one of the vehicle hardware input interfaces 136. Similarly, other inputs from other vehicle hardware 149 may be provided. In this respect, the vision system controller 119 may react to such inputs and execute various functions to perform tasks as will be described.

In addition, the vision system controller 119 may control or actuate various vehicle hardware 153. In this respect, output signals may be generated by the vision system controller 119 that are provided to the vehicle hardware output interfaces 139 that drive or actuate the vehicle hardware 153. The vehicle hardware 153 may comprise, for example, a vehicle horn, lights, audible alarms, or other hardware within the commercial vehicle 100.

The data bus interfaces 143 provide an interface so that the vision system controller 119 can obtain information from one or more vehicle data busses 156. In this respect, the vehicle data busses 156 may be described, for example, in various publicly available standards such as SAE J1587 entitled “Electronic Data Interchange Between Microcomputer Systems in Heavy-Duty Vehicle Applications published on Feb. 7, 2002 by the Society of Automotive Engineers (SAE); SAE J1939 entitled “Recommended Practice for a Serial Control and Communications Vehicle Network published on Aug. 7, 2003 by the Society of Automotive Engineers (SAE) (and all sub-standards referenced therein including J1939/01 (September 2000), J1939/11 (October 1999), J1939/13 (July 1999), J1939/21 (April 2001), J1939/31 (December 1997), J1939/71 (August 2002), J1939/73 (June 2001), J1939/75 (December 2002), and J1939/81 (May 2003)); and SAE J2497 entitled “Power Line Carrier Communications for Commercial Vehicles” published on Oct. 10, 2002 by the Society of Automotive Engineers (SAE), each of these standards being incorporated herein by reference in their entirety. The vision system controller 119 can obtain various information off of the vehicle data busses 156 and take such action as is deemed necessary as will be described. Also, the vision system controller 119 may transmit data onto one or more vehicle data busses 156 through the data bus interfaces 143.

In one embodiment, each of the cameras 106 includes a video output 159 that is coupled directly to the camera input multiplexer 131. Alternatively, the video output 159 from each of the cameras 106 may be transmitted to the vision system interface 109 using a common video bus that is coupled to each of the cameras 106. The vision system controller 119 also includes a data communication link with each of the cameras 106 to allow the vision system controller 119 to communicate therewith. In this respect, the vision system controller 119 may include a unique data communications link between each of the cameras 106 and the control processor 127 to facilitate communication between the vision system controller 119 and each of the cameras 106. Alternatively, a common communication bus 163 may be provided through which the vision system controller 119 may communicate with each of the cameras 106 using an addressing scheme as can be appreciated with those with ordinary skill in the art. If the cameras 106 transmit their video signals 159 on a common video bus, the vision system controller 119 may direct which one of the cameras 106 transmits at a given time to prevent a collision of the video signals 159 on such common video bus.

Next, the general operation of the components on the vision system interface 109 is discussed. The vision system controller 119 includes many different functions and acts as the general center of operation for the vision system interface 109. To this end, the vision system controller 119 reacts to any one of a number of different inputs that it receives and performs various tasks according to the logic. Specifically, the vision system controller 119 may receive inputs from vehicle hardware 149 such as, for example, braking systems, turn signal systems, vehicle steering systems, and other vehicle subsystems. Also, the vision system controller 119 may receive inputs generated by a voice recognition system included in the vehicle hardware 149. The vision system controller 119 may also receive operator input from appropriate operator input device 146 through the operator input interfaces 133. In this respect, signals may be generated by push buttons or other input devices that are manipulated by an operator to provide or select predefined functions of the vision system controller 119. In one embodiment, the push buttons may be included in the display screen 113.

In addition, inputs may be received by the vision system controller 119 from the one or more vehicle data busses 156 through the data bus interfaces 143. In this regard, the data bus interfaces 143 facilitate the capture of messages communicated on the data busses 156. The vision system controller 119 parses messages from the data busses 156 and reacts to such messages by performing various tasks. Such tasks may include, for example, forwarding a message detected on a vehicle data bus 156 to the screen overlay controller 126 to be displayed on the display device 113 to an operator.

Also, the vision system controller 119 may transmit messages onto the various vehicle data busses 156 in the commercial vehicle 100. Such messages may include diagnostic information for other subsystems within the commercial vehicle 100, or it may be information that directs one or more subsystems within the commercial vehicle 100 to take action as directed.

The vision system controller 119 may also react to inputs from the screen to screen analyzer 123. Specifically, the screen to screen analyzer 123 may inform the vision system controller 119 of movement that occurs in the environment surrounding the vehicle when the screen to screen analyzer 123 is placed in a security mode as will be discussed.

In addition, the vision system controller 119 may receive inputs from the cameras 106 by virtue of the communication bus 163. In this respect, the cameras 106 may inform the vision system controller 119 of various state information, diagnostic information, or other camera details. Also, the vision system controller 119 may control the operation of the cameras 106 by transmitting messages thereto. In this respect the vision system controller 119 may communicate with the cameras 106 according to a predefined protocol.

The vision system interface 109 provides significant advantages, including the fact that multiple sources of input information are localized in a single location such that information about the commercial vehicle 100 (FIG. 1) may be obtained from each of these inputs and the vision system controller 119 can perform various tasks in response thereto. Specifically, the vision system controller 119 may be programmed to sense or detect complex circumstances regarding the operation of the commercial vehicle 100 by reacting to combinations of the multiple inputs. For example, the vision system interface 109 can combine inputs from the vehicle hardware 149, vehicle data busses 156, and operator input devices 146 with input generated by the analysis of video signals 159 from the screen to screen analyzer 123 to provide more useful information for operators, etc. Such capability translates into the ability to provide greater awareness to operators as to the current circumstances surrounding the operation of a commercial vehicle 100 that leads to safer operation.

In addition, the vision system controller 119 may determine which video signal 159 from which of the cameras 106 is selected for display on the display device 113. Specifically, such a selection may be based upon the various inputs received as described above, or the selection may be made by logic programmed as part of the vision system controller 119 itself.

The vision system controller 119 drives the camera input multiplexer 131 to display the video signal 159 generated by the appropriate one of the cameras 106 to be passed on to the screen overlay controller 126 and to be provided to the screen to screen analyzer 123. Also, the vision system controller 119 may drive the vehicle hardware 149 as deemed appropriate based upon the various inputs to the vision system controller 119. In this respect, the vision system controller 119 may drive such vehicle subsystems as lights, reverse direction warning beepers, horns/audible alarms, or other warning apparatus on the commercial vehicle 100.

The vision system controller 119 may also supply messages to the screen overlay controller 126 to be displayed on the display device 113. The screen overlay controller 126 includes messages over the video signal 159, i.e. “overlays” such messages onto the video signal 159, and applies the combined video signal/message to the display device 113 for display. The messages may be in the form of text, icons, symbols, or other images.

The screen overlay controller 126 may perform the function of creating a mirror image of the video signal 159 received from a respective one of the cameras 106. In particular, the screen overlay controller 126 may include the capability of generating a mirror image of a video signal 159 received from one or more of the cameras 106 that are facing a rearward direction. In this respect, the vision system interface 109 will facilitate displaying images for an operator in a manner that avoids confusion as to the views displayed. In addition, the vision system controller 119 may perform other tasks as is deemed appropriate or necessary to provide for greater capabilities of vision systems within a commercial vehicle 100 as will be described.

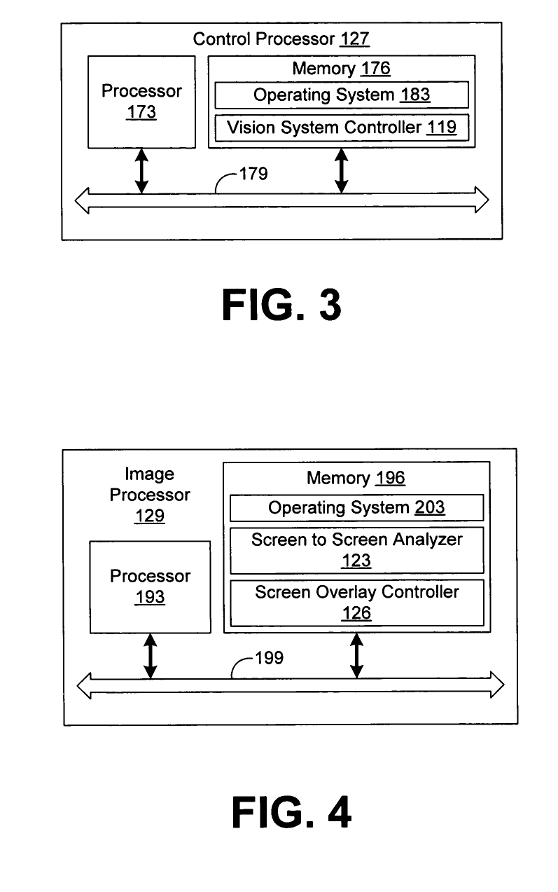

Turning then to FIG. 3, shown is a schematic that provides one example of the control processor 127 according to an aspect of the present invention. In this respect, the control processor 127 includes a processor 173 with a memory 176, both of which are coupled to a local interface 179. In this respect, the local interface 179 may comprise, for example, a data bus with an accompanying control/address bus asking those with ordinary skill in the art. The control processor 127 may be, for example, the MC9S12DG12 microprocessor manufactured by Motorola Corporation that is located at Schaumburg, Ill. Stored in the memory 176 and executable by the processor are an operating system 183 and the vision system controller 119. In this respect, the operating system 183 may be stored in nonvolatile memory. Also, the vision system controller 119 may be stored in volatile or nonvolatile memory and may be replaced with updated versions of the same.

With reference to FIG. 4, shown is a schematic of the image processor 129 according to another embodiment of the present invention. In this respect, the image processor 129 includes a processor 193 and a memory 196, both of which are coupled to a local interface 199. In this respect, the local interface 199 may comprise, for example, a data bus with an accompanying control/address bus as can be appreciated by those with ordinary skill in the art. The image processor 129 may be, for example, an AL700 microprocessor manufactured by Averlogic Technologies of San Jose, Calif. or other appropriate processor. Stored in the memory 196 and executable by the processor 193 are an operating system 203, the screen to screen analyzer 123, and the screen overlay controller 126. In this respect, the operating system 203 may be expressed, for example, in nonvolatile memory. Likewise, the screen to screen analyzer 123 and the screen overlay controller 126 may be expressed in volatile or nonvolatile memory and may be replaced with updated versions of the same.

The memories 176 and 196 are each defined herein as both volatile and nonvolatile memory and data storage components. Volatile components are those that do not retain data values upon loss of power. Nonvolatile components are those that retain data upon a loss of power. Thus, each of the memories 176 and 196 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), FLASH memory, or other like memory device.

Also, each of the processors 173 and 193 may represent multiple processors and each of the memories 176 and 196 may represent multiple memories that operate in parallel processing circuits, respectively. In such a case, each of the local interfaces 179 and 199 may be an appropriate network that facilitates communication between any two of the multiple processors, between any processor and any of the memories, or between any two of the memories, etc. The processors 173 and 193 may be of electrical, optical, or molecular construction, or of some other construction as can be appreciated by those with ordinary skill in the art.

Each of the operating systems 183 and 203 are executed to control the allocation and usage of hardware resources such as the memory, processing time and peripheral devices in the control and image processors 127 and 129. In this manner, the operating systems 183 and 203 serve as the foundation on which applications depend as is generally known by those with ordinary skill in the art.

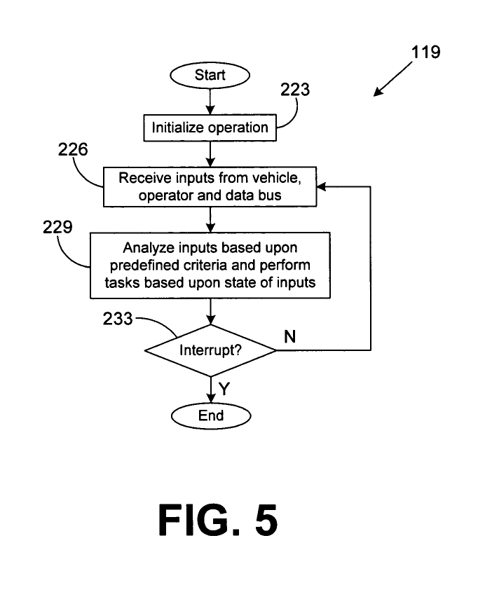

Referring next to FIG. 5, shown is a flow chart that provides one example of the operation of the vision system controller 119 according to an embodiment of the present invention. Alternatively, the flow chart of FIG. 5 may be viewed as depicting steps of an example of a method implemented in the control processor 127 to control the functions of the vision system interface 109 (FIG. 2). The functionality of the vision system controller 119 as depicted by the example flow chart of FIG. 5 may be implemented, for example, in an object oriented design or in some other programming architecture. Assuming the functionality is implemented in an object oriented design, then each block represents functionality that may be implemented in one or more methods that are encapsulated in one or more objects. The vision system controller 119 may be implemented using any one of a number of programming languages such as, for example, C, Assembly Language, or other programming languages.

As was stated previously, the vision system interface 109 provides significant advantages, including the fact that multiple sources of input information are localized in a single location such that information about the commercial vehicle 100 (FIG. 1) may be obtained from each of these inputs and the vision system controller 119 can perform various tasks in response thereto. Specifically, information is obtained, for example, from the operator input devices 146 (FIG. 2), the vehicle hardware 149 (FIG. 2), the vehicle data bus(es) 156 (FIG. 2), and the screen to screen analyzer 123. In this respect, the vision system controller 119 may be configured to react to the information received from these input sources to provide more useful information to operators via the display device 113 (FIG. 2) and the vehicle hardware 153 (FIG. 2). Also, the vision system controller 119 may control the vehicle hardware 153 to provide warnings to the operators or third parties around the commercial vehicle 100. Still further, the vision system controller 119 may transmit messages on the vehicle data bus(es) 156.

Beginning with box 223, the vision system controller 119 initializes operation after startup of the vision system interface 109. In this respect, any variable may be set to default values and other actions are taken to ready operation of the vision system interface 109. Also, the vision system controller 119 may communicate with the cameras 106 (FIG. 2), the camera input multiplexer 131 (FIG. 2), the screen overlay controller 126 and any other necessary components to initialize their operation as may be required. Thereafter, in box 226, the vision system controller 119 receives inputs from the vehicle operator via the operator input devices 146, the vehicle hardware 149, the vehicle data bus(es) 156, and the screen to screen analyzer 123. The inputs from the operator input devices 146 and the vehicle hardware 149 may comprise signals that are accessed by the vision system controller 119. The inputs from the vehicle data bus(es) 156 are determined by listening on the data bus(es) 156 and parsing messages taken from the data bus(es) 156.

Once the state of all inputs is determined or any inputs are received in box 226, then in box 229 the vision system controller 119 analyzes the inputs based upon predefined criteria or logic and performs various tasks based upon the state of the inputs detected or received. In this respect, the vision system controller 119 may communicate with the cameras 106, the camera input multiplexer 131, the screen to screen analyzer 123, the screen overlay controller 126, or other appropriate component as necessary. Also, the vision system controller 119 may perform such tasks as directing the screen overlay controller 126 to display appropriate messages on the display device 113 or may drive the vehicle hardware 153. Still further, the vision system controller 119 may transmit messages on the vehicle data bus(es) 156 to communicate with other subsystems in the commercial vehicle 100. In this respect, the vision system controller 119 provides flexibility in what it can accomplish given that it may communicate with and control many different components in the commercial vehicle 100.

Next, in box 233, the vision system controller 119 determines whether its function is to be interrupted. An appropriate interrupt may be, for example, and error condition or a shutdown input from an operator, etc. If no interrupt occurs, the vision system controller 119 reverts back to box 226. Otherwise, the vision system controller 119 ends accordingly. In this respect, the vision system controller 119 continually monitors the state of and receives inputs and performs various tasks in response thereto, depending upon the logic executed as a portion of the vision system controller 119. In later discussion, examples of logic executed as a portion of the vision system controller 119 is provided.

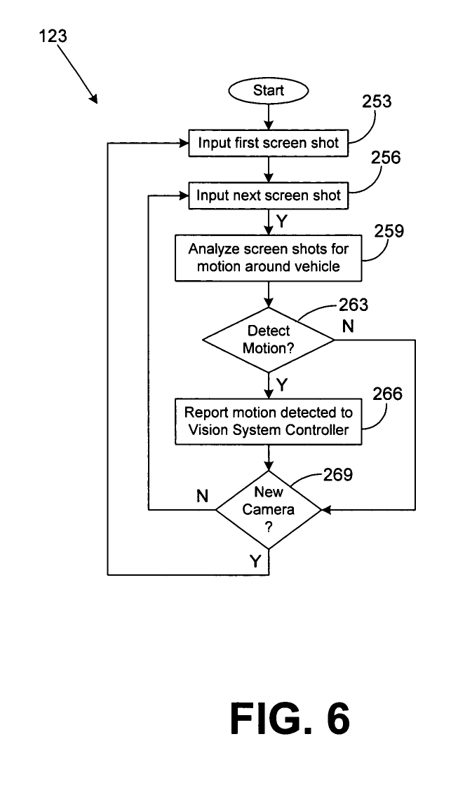

Referring next to FIG. 6, shown is a flow chart that provides one example of an operation performed by the screen to screen analyzer 123 according to an embodiment of the present invention. Alternatively, the flow chart of FIG. 6 may be viewed as depicting steps of an example of a method implemented in the vision system interface 109 (FIG. 1) to analyze the video signal 159 (FIG. 2) from the cameras 106 to detect motion in the environment surrounding the commercial vehicle 100. The functionality of the screen to screen analyzer 123 as depicted by the example flow chart of FIG. 6 may be implemented, for example, in an object oriented design or in some other programming architecture. Assuming the functionality is implemented in an object oriented design, then each block represents functionality that may be implemented in one or more methods that are encapsulated in one or more objects. The screen to screen analyzer 123 may be implemented using any one of a number of programming languages such as, for example, C, Assembly Language, or other programming languages.

The screen to screen analyzer 123 is employed, for example, to analyze consecutive screen shots from one of the cameras 106 to detect various conditions or situations. For example, the screen to screen analyzer 123 may be employed to provide security around the commercial vehicle 100. In this respect, the screen to screen analyzer 123 may be employed to detect motion in the environment around the commercial vehicle 100, for example, when the commercial vehicle 100 is at rest. In this respect, the screen to screen analyzer 123 may operate in a security mode in which motion around the commercial vehicle 100 is sensed by virtue of screen to screen analysis from respective ones of the cameras 106. When in the security mode, the screen to screen analyzer 123 communicates with the vision system controller 119 to determine which of the cameras 106 is to provide a video signal 159 to the screen to screen analyzer 123. In this respect, each camera 106 may be selected in turn as a constant sweep around the commercial vehicle 100 is made where screen to screen analysis is performed using the video signal 159 from each of the cameras 106 consecutively.

As to a specific example of the operation of the screen to screen analyzer 123, beginning with box 253, the screen to screen analyzer 123 acquires a first screen shot from the current selected one of the cameras 106 (FIG. 2) through the camera input multiplexer 131 (FIG. 2). Thereafter, in box 256, the screen to screen analyzer 123 acquires a second or subsequent screen shot from the same camera 106. Then in box 259, the screen to screen analyzer 123 analyzes the screen shots taken in boxes 253 and 256 to identify motion around the commercial vehicle 100. Thereafter, in box 263, the screen to screen analyzer 123 determines whether motion has been detected by analyzing the screen shots.

If motion is detected in box 263, then the screen to screen analyzer 123 proceeds to box 266 in which the motion detected is reported to the vision system controller 119 that may then take appropriate action and perform appropriate tasks in response thereto. Thereafter, the screen to screen analyzer proceeds to box 269. However, if no motion is detected in box 263, then in box 269 the screen to screen analyzer 123 determines whether a new camera 106 has been selected by the vision system controller 119, the video signal 159 from which is to be displayed on the display device 113. If no new camera 106 is selected, then the screen to screen analyzer 123 reverts back to box 256. In this respect, the next screen shot is taken and compared to the last screen shot taken in box 256 on the prior occasion. On the other hand, if the new camera 106 has been selected, then the screen to screen analyzer 123 reverts back to box 253 in order to ensure that two screen shots are taken from the new camera 106 to properly perform the comparison analysis.

While the flow chart of FIG. 6 illustrates the functionality of the screen to screen analyzer 123 with respect to motion detection around the commercial vehicle 100, it is understood that the screen to screen analyzer 123 may be programmed or configured to detect other aspects about the operation of the commercial vehicle 100.

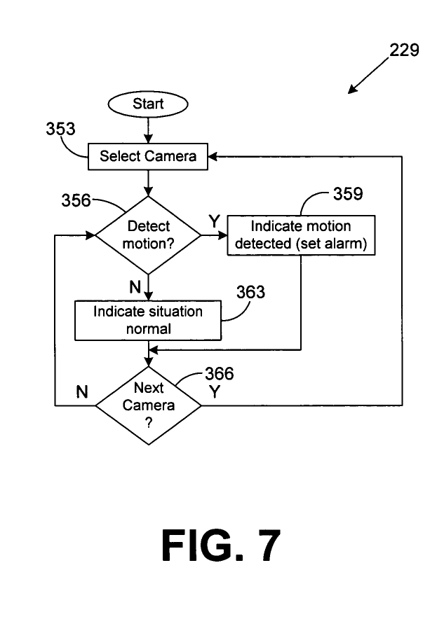

Referring next to FIG. 7, shown is a flow chart that provides one example of the operation of a portion of the vision system controller 119, denoted herein as vision system controller task 229 according to an embodiment of the present invention. Alternatively, the flow chart of FIG. 7 may be viewed as depicting steps of an example of a method implemented in the vision system interface 109 (FIG. 2) to detect motion around the commercial vehicle 100 (FIG. 1) when in security mode. The functionality of the vision system controller task 229 as depicted by the example flow chart of FIG. 7 may be implemented, for example, in an object oriented design or in some other programming architecture. Assuming the functionality is implemented in an object oriented design, then each block represents functionality that may be implemented in one or more methods that are encapsulated in one or more objects. The vision system controller task 229 may be implemented using any one of a number of programming languages such as, for example, C, Assembly Language, or other programming languages.

Beginning with box 353, the vision system controller task 229 selects one of the cameras 106 (FIG. 2) for which motion is to be detected. In this respect, the vision system controller task 229 may manipulate the camera input multiplexer 131 (FIG. 1) to select a video signal 159 from one of the cameras 106 to be analyzed by the screen to screen analyzer 123.

Thereafter, in box 256, the vision system controller task 229 determines whether motion is detected within the viewing area of the selected one of the cameras 106. This may be ascertained by communicating appropriately with the screen to screen analyzer 123 (FIG. 6) that provides an input as to whether motion is detected. If motion is detected, then the vision system controller task 229 proceeds to box 359. Otherwise, the vision system controller task 229 progresses to box 363.

In box 359, the vision system controller task 229 indicates that motion around the commercial vehicle 100 has been detected by the respective camera 106. In this respect, the vision system controller task 229 may send a message to be displayed on the display device 113 to the screen overlay controller 126 that informs the operator that motion is detected. The message may inform the operator of the direction relative to the commercial vehicle 100 that the motion was detected, given that a number of views may be possible with multiple cameras 106 mounted in various positions around the commercial vehicle 100. In addition, other audible alarms may sound or lights or indicators may be illuminated, such alarms, lights or indicators being part of the vehicle hardware 153 driven by the vision system controller 119. As an additional alternative, the vision system controller task 229 may transmit a message to a remote location to inform personnel of the movement around the vehicle. In this respect, the message may be transmitted via a wireless network, cellular network, pager network, or other appropriate network. From box 359, the vision system controller task 229 proceeds to box 366.

Assuming that no motion was detected in box 356, then the vision system controller task 229 proceeds to box 363 in which an indication is provided to the operator that no motion was detected and that the commercial vehicle is secure. This may comprise displaying a “Vehicle Secure” message or its equivalent on the display device 113. Also, other audible indicators, indicator lights, or other hardware that is included in the vehicle hardware 153 may be activated to indicate that the commercial vehicle 100 is secure. Thereafter, the vision system controller task 229 may proceed to box 366.

In box 366, the vision system controller task 229 determines whether a view from a different camera 106 on the commercial vehicle 100 is to be analyzed. If so, then the vision system controller task 229 reverts back to box 353 in which the next camera 106 is selected for motion analysis. In this respect, the vision system controller task 229 may cycle through each of the cameras 106 according to a predetermined priority. Also, the time periods within which the analysis is performed with each of the cameras 106 may also be predetermined, and such time periods may vary from camera to camera 106, depending upon the importance of the views offered. Assuming that there is no switch to a new camera 106 to be performed in box 366, then the vision system controller task 229 reverts back to box 356 to determine if motion has been detected.

Although the vision system controller 119, screen to screen analyzer 123, and the screen overlay controller 126 are depicted as being embodied in software or code executed in processor circuits as discussed above, as an alternative each may also be embodied in dedicated hardware or a combination of software/general purpose hardware and dedicated hardware. If embodied in dedicated hardware, the vision system controller 119, screen to screen analyzer 123, and the screen overlay controller 126 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 5-7 show examples of the architecture, functionality, and operation of an implementation of the vision system controller 119 and/or the screen to screen analyzer 123. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow charts of FIGS. 5-7 show a specific order of execution, it is understood that the order of execution may differ from that which is depicted. For example, the order of execution of two or more blocks may be scrambled relative to the order shown. Also, two or more blocks shown in succession in FIGS. 5-7 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the vision system controller 119 and/or the screen to screen analyzer 123 comprise software or code, each can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the vision system controller 119 and/or the screen to screen analyzer 123 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

1. A vision system interface for use in a commercial vehicle, comprising:
at least one input through which at least one of a plurality of video signals is received from a corresponding plurality of cameras for display on a display device;
a vision system controller facilitating a selection of at least one of the video signals that is to be displayed on the display device, the vision system controller being adapted to generate at least one message to be displayed on the display device; and
a screen overlay controller adapted to overlay the at least one message onto the at least one selected one of the video signals for display on the display device.

2. The vision system interface of claim 1, wherein the at least one input further comprises a video bus input adapted to receive a video bus, wherein the video bus is coupled to a video output of each of the cameras.

3. The vision system interface of claim 2, wherein the video system controller further comprises a data communication link with each of the cameras, wherein the video system controller selects which one of the cameras is to transmit a corresponding one of the video signals on the video bus for display on the display device.

4. The vision system interface of claim 1, further comprising a camera input multiplexer, the at least one input comprising a number of video inputs of the camera input multiplexer, wherein each video input is adapted to receive a video output from one of the cameras.

5. The vision system interface of claim 1, further comprising power conditioning circuitry adapted to condition power received from a vehicle power source, wherein the power condition circuitry is coupled to a power input of the display device and to a power input of each of the cameras, the power condition circuitry supplying power to the display device and the cameras.

6. The vision system interface of claim 1, wherein the vision system controller is coupled to a vehicle data bus, the vision system controller obtaining information from the vehicle data bus.

7. The vision system interface of claim 6, wherein the at least one message overlaid onto the video signal comprises the information from the vehicle data bus.

8. The vision system interface of claim 1, wherein the vision system controller is coupled to a vehicle hardware of a commercial vehicle, wherein the vision system controller receives information relating to the operation of the vehicle hardware.

9. The vision system interface of claim 1, further comprising a screen to screen analyzer adapted to detect motion in a view embodied in the selected one of the video signals generated by one of cameras.

10. A vision system interface method employed in a commercial vehicle, comprising the steps of:
receiving at least one of a plurality of video signals at a vision system interface, each of the video signals being generated by a camera on the commercial vehicle;
selecting one of the video signals from one of the cameras for display on a display device using a vision system controller on the vision system interface;
generating at least one message with the vision system controller to be displayed on the display device; and
overlaying the at least one message onto the video signal for display on the display device.

11. The vision system interface method of claim 10, wherein the at least one of the plurality of video signals is received at the vision system interface through a video bus input, wherein the video bus is coupled to a video output of each of the cameras.

12. The vision system interface method of claim 11, further comprising the steps of:
establishing a data communication link between the video system interface and each of the cameras; and
selecting which one of the cameras is to transmit a corresponding one of the video signals on the video bus for display on the display device.

13. The vision system interface method of claim 10, wherein each of the at least one of the plurality of video signals is received at a video input of a camera input multiplexer on the video system interface.

14. The vision system interface method of claim 10, further comprising the steps of:
conditioning power using a power conditioning circuit in the vision system interface, the power being received from a vehicle power source; and
supplying the power conditioned by the power conditioning circuit to the display device and to each of the cameras.

15. The vision system interface method of claim 10, further comprising the step of applying information from a vehicle data bus to the vision system controller.

16. The vision system interface method of claim 15, wherein the at least one message overlaid onto the video signal comprises the information from the vehicle data bus.

17. The vision system interface method of claim 10, further comprising the step of:
coupling the vision system controller to a vehicle hardware in a commercial vehicle; and
receiving information relating to the operation of the vehicle hardware in the vision system controller.

18. The vision system interface method of claim 10, further comprising the step of detecting a motion in a view embodied in the selected one of the video signals using a screen to screen analyzer.

19. A vision system interface for use in a commercial vehicle, comprising:
means for selecting one of a plurality of the video signals generated by a corresponding plurality of cameras for display on a display device;
means for generating at least one message to be displayed on the display device concurrently with the selected one of the video signals; and
means for overlaying the at least one message onto the selected one of the video signals for display on the display device.

20. The vision system interface of claim 11, further comprising means for selecting which one of the cameras is to transmit a corresponding one of the video signals on a common video bus coupled to the vision system interface for display on the display device.

21. The vision system interface of claim 10, wherein the means for selecting one of the video signals further comprises a camera input multiplexer on the video system interface.

22. The vision system interface of claim 10, further comprising means for conditioning power from a vehicle power source, thereby generating conditioned power, wherein the conditioned power is supplied to the display device and to each of the cameras.

23. The vision system interface of claim 19, means for receiving information from a vehicle data bus in the vision system interface.

24. The vision system interface of claim 23, wherein the at least one message overlaid onto the video signal comprises the information from the vehicle data bus.

25. The vision system interface of claim 19, further comprising means for receiving information relating to the operation of a vehicle hardware of the commercial vehicle in the vision system interface.

26. The vision system interface of claim 19, further comprising means for detecting motion in a view embodied in the selected one of the video signals generated by one of cameras.
